(19) United States
(12) Patent Application Publication
(10) Pub. No.: US 2025/0136133 A1
(43) Pub. Date: May 1, 2025

(54) INTERSECTION ASSISTANT FOR ALL-WAY STOP SCENARIOS

(71) Applicant: FCA US LLC, Auburn Hills, MI (US)

(72) Inventors: Randy T. Gerken, White Lake, MI (US); Jason C. Hedlund, West Bloomfield, MI (US)

(21) Appl. No.: 18/496,967

(22) Filed: Oct. 30, 2023

(51) Int. Cl. B60W 50/14; B60W 30/18; B60W 40/04; H04W 4/44

(52) U.S. Cl. CPC B60W 50/14; B60W 30/18159; B60W 40/04; H04W 4/44; B60W 2050/146; B60W 2554/406; B60W 2556/45

(57) ABSTRACT

An intersection assistance technique for a vehicle includes obtaining intersection information relative to an all-way stop scenario that involves a plurality of vehicles including the vehicle and, in response to detecting the all-way stop scenario, executing an intersection assistance procedure including, based on the set of intersection information, determining a sequential order in that the plurality of vehicles should proceed during the all-way stop scenario, and controlling a display of the vehicle to display graphical information based on the determined sequential order, where the display of the graphical information assists a driver of the vehicle in navigating the all-way stop scenario.

### FIELD

The present application generally relates to all-way stop scenarios for vehicles and, more particularly, to an intersection assistant that assists a driver in navigating a vehicle all-way stop scenario.

### BACKGROUND

All-way stop scenarios, such as a four-way stop sign scenario, have long been a point of frustration for human drivers and, in some cases, accidents/collisions. All-way stop scenarios can also include three-way stop and five-way stop scenarios and scenarios where there is a traffic light malfunction and vehicles are supposed to default to all-way stop type behavior. These scenarios become even more difficult when autonomous vehicles are involved, because (i) autonomous vehicles may tend to perform poorly during these scenarios (e.g., a very hesitant or overlay cautious stop-and-go procedure) and (ii) autonomous vehicles are unable to participate in human interaction (e.g., hand gestures, such as waving). Some conventional solutions to this problem utilize central management or vehicle autonomous systems, but these solutions are limited to newer autonomous vehicles. Accordingly, while such conventional autonomous vehicle systems do work well for their intended purpose, there exists an opportunity for improvement in the relevant art.

### SUMMARY

According to one example aspect of the invention, an intersection assistance system for a vehicle is presented. In one exemplary implementation, the intersection assistance system comprises a set of vehicle systems each configured to determine intersection information relative to an all-way stop scenario that involves a plurality of vehicles including the vehicle, wherein the intersection information determined by each of the set of vehicle systems collectively forms a set of intersection information, and a controller connected to the set of vehicle systems and configured to execute an intersection assistance procedure in response to detecting the all-way stop scenario, the intersection assistance procedure including obtaining, from the set of vehicle systems, the intersection information, based on the set of intersection information, determining a sequential order in that the plurality of vehicles should proceed during the all-way stop scenario, and controlling a display of the vehicle to display graphical information based on the determined sequential order, wherein the display of the graphical information assists a driver of the vehicle in navigating the all-way stop scenario.

In some implementations, the controller is further configured to update the sequential order in that a remainder of the plurality of vehicles should proceed after one of the plurality of vehicles has traversed and left the all-way stop scenario. In some implementations, the graphical information includes a display of the sequential order of the plurality of vehicles including a current instruction for the driver of the vehicle to either wait and remain stopped, proceed, or proceed with caution. In some implementations, the graphical information further includes a simulated overhead display of the all-way stop scenario. In some implementations, the display includes at least one of (i) an in-dash display and (ii) a display of a central infotainment system of the vehicle.

In some implementations, the set of vehicle systems includes a perception system configured to perceive an environment external to the vehicle, and the information from the perception system includes a time that each vehicle of the plurality of vehicles arrived at the all-way stop scenario. In some implementations, the set of vehicle systems includes a vehicle communication system configured for vehicle-to-anything (V2X) communication. In some implementations, the information from the vehicle communication system includes other intersection information received, either directly or via a central server, from one or more of a remainder of the plurality of vehicles. In some implementations, the all-way stop scenario is an all-way stop sign scenario. In some implementations, the all-way stop scenario is a multi-way intersection that has a malfunctioning traffic light.

According to another example aspect of the invention, an intersection assistance method for a vehicle is presented. In one exemplary implementation, the intersection assistance method comprises obtaining, by a controller and from a set of vehicle systems, intersection information relative to an all-way stop scenario that involves a plurality of vehicles including the vehicle, wherein the intersection information determined by each of the set of vehicle systems collectively forms a set of intersection information and, in response to detecting the all-way stop scenario, executing, by the controller, an intersection assistance procedure including obtaining, from the set of vehicle systems, the set of intersection information, based on the set of intersection information, determining a sequential order in that the plurality of vehicles should proceed during the all-way stop scenario, and controlling a display of the vehicle to display graphical information based on the determined sequential order, wherein the display of the graphical information assists a driver of the vehicle in navigating the all-way stop scenario.

In some implementations, the method further comprises updating, by the controller, the sequential order in that a remainder of the plurality of vehicles should proceed after one of the plurality of vehicles has traversed and left the all-way stop scenario. In some implementations, the graphical information includes a display of the sequential order of the plurality of vehicles including a current instruction for the driver of the vehicle to either wait and remain stopped, proceed, or proceed with caution. In some implementations, the graphical information further includes a simulated overhead display of the all-way stop scenario. In some implementations, the display includes at least one of (i) an in-dash display and (ii) a display of a central infotainment system of the vehicle.

In some implementations, the set of vehicle systems includes a perception system configured to perceive an environment external to the vehicle, and the information from the perception system includes a time that each vehicle of the plurality of vehicles arrived at the all-way stop scenario. In some implementations, the set of vehicle systems includes a vehicle communication system configured for V2X communication. In some implementations, the information from the vehicle communication system includes other intersection information received, either directly or via a central server, from one or more of a remainder of the plurality of vehicles. In some implementations, the all-way stop scenario is an all-way stop sign scenario. In some implementations, the all-way stop scenario is a multi-way intersection that has a malfunctioning traffic light.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having an example all-way stop assistance system according to the principles of the present application;

FIGS. 2A-2B are diagrams of an example all-way stop (e.g., four-way stop sign) scenario and a determined sequential vehicle order according to the principles of the present application; and

FIG. 3 is a flow diagram of an example all-way stop assistance method executable by a controller of a vehicle according to the principles of the present application.

### DESCRIPTION

As previously discussed, all-way stop scenarios for vehicles are a particular point of frustration for human drivers and could potentially result in accidents. Accordingly, improved intersection assistance systems and methods for vehicle all-way stop scenarios are presented herein. These techniques assist human drivers in navigating all-way stop scenarios, including those where autonomous vehicles are involved. The term “all-way stop scenario” as used herein includes any number of multiple way intersections/scenarios where all possible ways are required to stop (two-way, three-way, four-way, five-way, etc.). This includes both “all-way stop sign scenarios” where all of the possible ways have a stop sign and multi-way intersections where a traffic light is malfunctioning and the vehicles must legally behave as if there is an all-way stop sign scenario. For example, a scenario with two-way stop signs and also another intersecting or crossing lane where the vehicles are not required to stop (i.e., no stop signs) would not be an all-way stop or all-way stop sign scenario.

These techniques leverage the speed of mobile edge computing (5G cellular networks, graphical processing units or GPUs, etc.) for fast vehicle communication (vehicle-to-vehicle, vehicle-to-server, vehicle-to-Internet, etc.) to gather information that is processed to determine a sequential order for the all-way stop scenario. A graphical interface is displayed to the driver, such as on an instrument panel cluster (IPC) or infotainment touch display, which shows an example intersection and the vehicles with their corresponding “turn” in the sequential order. This sequential order determination can also utilize other information such as global positioning system (GPS) data and vehicle vision/perception systems (e.g., vehicle cameras).

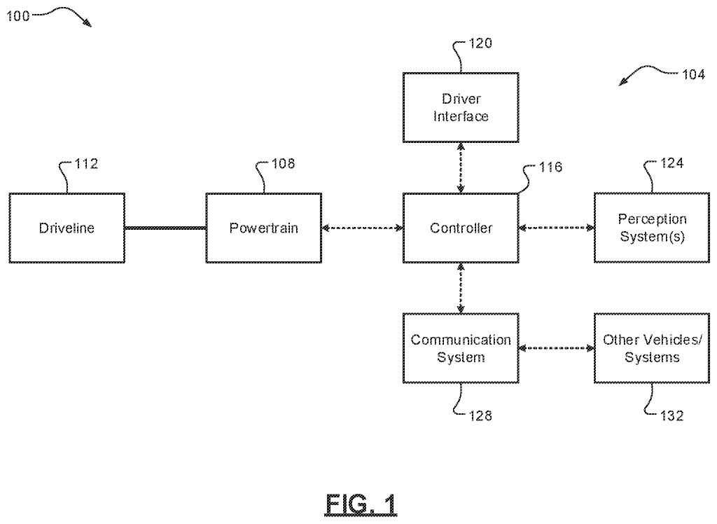

Referring now to FIG. 1, a functional block diagram of a vehicle 100 having an example intersection assistance system 104 according to the principles of the present application is illustrated. The vehicle 100 generally comprises a powertrain 108 configured to generate and transfer drive torque to a driveline 112 for vehicle propulsion. A controller 116 controls operation of the vehicle 100, including controlling the powertrain 108 to generate and transfer an amount of drive torque to the driveline 112 to satisfy a driver torque request, which could be provided via a driver interface 120. The driver interface 120 could include any suitable driver input/output components, such as, but not limited to, an accelerator pedal, a brake pedal, an IPC, and an infotainment system having a touch display. It will be appreciated that these are merely examples of components of the driver interface 120 and that the vehicle 100 or the driver interface 120 could include any suitable driver/user input/output components (switches, rotary knobs, etc.) for controlling vehicle functionality.

The vehicle 100 also includes a set of one or more perception systems 124 that are each configured to monitor or capture information relating to a perceived environment external to the vehicle 100. Non-limiting examples of these perception system(s) 124 include radio detection and ranging (RADAR) sensors, light detection and ranging (LIDAR) sensors, and camera systems. It will be appreciated that the perception system(s) 124 could also include other suitable systems for vehicle position localization, such as a GPS system (e.g., a global navigation satellite system, or GNSS transceiver).

The vehicle 100 further includes a communication system 128 (e.g., a wireless transceiver) configured for wireless communication with other vehicles/systems 132 via one or more wireless communication mediums. Non-limiting examples of these wireless communication mediums include longer range cellular networks (4G, 5G, etc.) and shorter range WiFi (e.g., WiFi Direct) and Bluetooth networks. The communication system 128 enables the vehicle 100 for vehicle-to-anything (V2X) communication, including, but not limited to, communication with other vehicles, roadside V2X devices, and remote servers. The controller 116 is configured to control and transmit/receive information via the communication system 128.

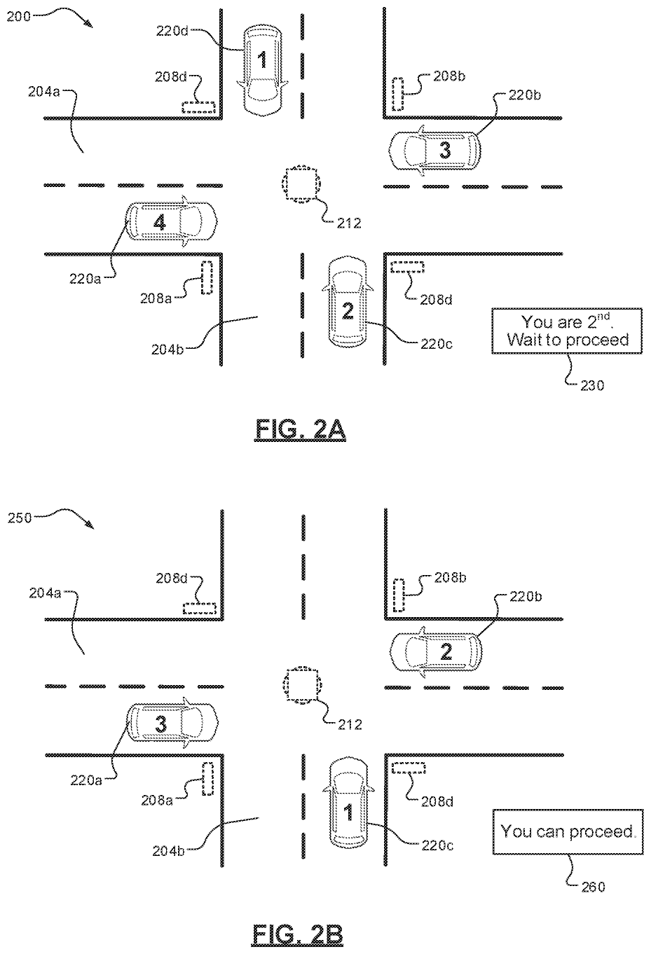

Referring now to FIGS. 2A-2B and with continued reference to FIG. 1, diagrams 200, 250 of an example all-way stop (e.g., four-way stop sign) scenario and a determined sequential vehicle order according to the principles of the present application are illustrated. The illustrated all-way stop scenario shows two intersecting roadways 204a and 204b where up to four vehicles could potentially be stopped. This could be either (i) a four-way stop sign scenario where there are four stop signs 208a-208d indicating for approaching vehicles to stop before proceeding or (ii) a malfunctioning traffic light 212, upon which vehicles are supposed to behave (i.e., per local driving rules/regulations) as if the intersection is a four-way stop sign scenario. In either case, in the first stage 200 of the all-way stop scenario as illustrated by FIG. 2A, there are four vehicles 220a-220d (collectively, “vehicle 220”) stopped at the intersection.

For newer vehicles that are equipped with V2X communication capability, the vehicles 220 may communicate with each other in determining the sequential order for which they are to proceed through the intersection. The vehicles 220 may also be equipped with perception systems for determining an order in which each of the other vehicles 220 arrived at the intersection in order to determine the sequential order for proceeding.

For any older/legacy vehicles 220 (“not connected” vehicles) that do not have V2X communication capability and/or perception systems, it is assumed that the drivers of the vehicles 220 will operate according to the local driving rules/regulations), which should correspond to the sequential order determined by the connected/newer vehicles 220. As shown, the sequential order 1-4 is labeled for vehicles 220d, 220c, 220b, and 220a in FIG. 2A, meaning that these vehicles 220 arrived at the intersection in the opposite of that order. This overhead diagram 200 may be displayed to a driver of the vehicle (e.g., vehicle 220c) on an IPC, infotainment touch display, or other suitable graphical display. It will also be appreciated that another similar graphical representation of the intersection and the sequential order could be output to the driver.

For example, a message could be additionally or alternatively provided, such as message 230 that indicates to the driver of vehicle 220c that “You are 2^{nd}. Wait to proceed.” In the diagram 250 or second stage of the all-way stop scenario as illustrated in FIG. 2B, vehicle 220d has traversed the intersection and vehicle 220c is now next in the sequential order (which has been updated). A different or updated message 260 (e.g., “You can proceed.”) could be displayed to the driver of vehicle 220c, after which they can operate vehicle 220c to traverse the intersection.

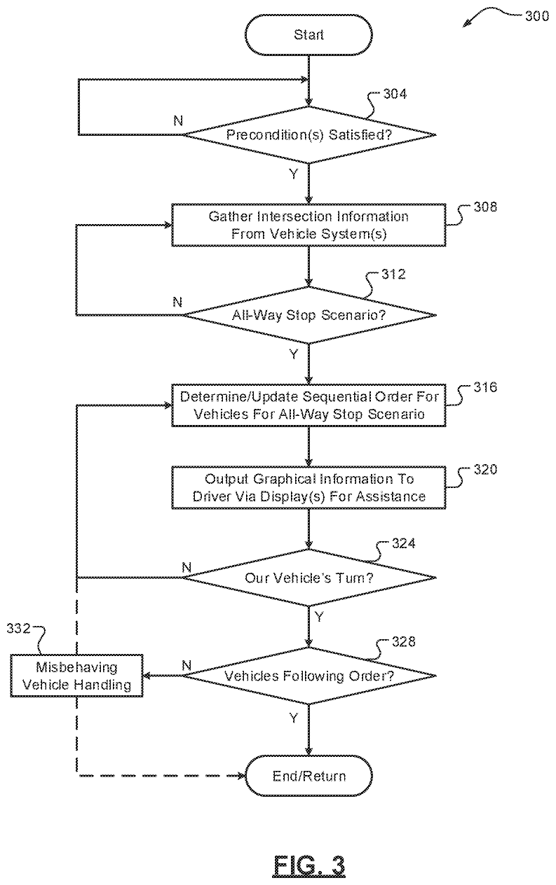

Referring now to FIG. 3, a flow diagram of an example intersection assistance method 300 for a vehicle according to the principles of the present application is illustrated. While the method 300 specifically references vehicle 100 and its components for illustrative/descriptive purposes, it will be appreciated that the method 300 could be applicable to any suitably configured vehicle. At 204, the controller 116 determines whether an optional set of one or more preconditions are satisfied. These precondition(s) could include, for example only, the vehicle 100 being powered up and running and there being no malfunctions or faults present that would otherwise inhibit the intersection assistance techniques of the present application. When false, the method 300 ends or returns to 304. When true, the method 300 continues to 308. At 308, the controller 116 gathers a set of information relating to an all-way stop scenario from a set of vehicle systems, which could include the perception systems 124 and/or the other vehicles/systems 132 (via the communication system 128).

At 312, the controller 116 is configured to detect whether an all-way stop scenario is present based on the set of information. This set of information could also include specific intersection information (e.g., relative times at which each vehicle arrived at the intersection) for determining the sequential order for the vehicles involved to traverse the intersection. When false, the method 300 ends or returns to 308. When true, the method 300 proceeds to 316.

At 316, the controller 116 is configured to begin executing an intersection assistance procedure by, based on the set of intersection information, determining a sequential order in that the vehicles should proceed during the all-way stop scenario. At 320, the controller 116 is configured to control a display (an IPC display, an infotainment unit touch display, etc.) to display graphical information (e.g., diagrams 200, 250) based on the determined sequential order. The display of the graphical information assists a driver of the vehicle in navigating the all-way stop scenario and could include text, images, or a combination thereof such as the simulated overhead views of FIGS. 2A-2B. At 324, the controller 116 determines whether it is the turn of the vehicle 100 to proceed through the all-way stop scenario. When false, the method 300 returns to 316 where the controller 116 monitors the situation and updates the sequential order at 316 and the graphical display at 320 after another vehicle traverses the all-way stop scenario. When true (i.e., it is the turn of the vehicle 100), the method 300 proceeds to 328 where the controller 116 verifies that the vehicles are following the order before proceeding.

When true, the vehicle 100 traverses the all-way stop scenario and the method 300 ends. When false, the method 300 proceeds to 332 where the controller 116 could perform some sort of remedial action or handling of the misbehaving vehicle. This could include, for example, waiting for the misbehaving vehicle to leave or traverse the all-way stop scenario, and then the vehicle 100 could proceed or proceed with caution, which could include some elevated perception monitoring, and the method 300 could end. Alternatively, the method 300 could return to 316 where the sequential order could be updated and the graphical display could be updated at 320 taking into account the misbehaving vehicle's action. Once 324 and 328 are determined to be true, the vehicle 100 could then proceed through the all-way stop scenario.

It will be appreciated that the term “controller” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An intersection assistance system for a vehicle, the intersection assistance system comprising:
a set of vehicle systems each configured to determine intersection information relative to an all-way stop scenario that involves a plurality of vehicles including the vehicle, wherein the intersection information determined by each of the set of vehicle systems collectively forms a set of intersection information; and
a controller connected to the set of vehicle systems and configured to execute an intersection assistance procedure in response to detecting the all-way stop scenario, the intersection assistance procedure including:
obtaining, from the set of vehicle systems, the intersection information;
based on the set of intersection information, determining a sequential order in that the plurality of vehicles should proceed during the all-way stop scenario; and
controlling a display of the vehicle to display graphical information based on the determined sequential order,
wherein the display of the graphical information assists a driver of the vehicle in navigating the all-way stop scenario.

2. The intersection assistance system of claim 1, wherein the controller is further configured to update the sequential order in that a remainder of the plurality of vehicles should proceed after one of the plurality of vehicles has traversed and left the all-way stop scenario.

3. The intersection assistance system of claim 1, wherein the graphical information includes a display of the sequential order of the plurality of vehicles including a current instruction for the driver of the vehicle to either wait and remain stopped, proceed, or proceed with caution.

4. The intersection assistance system of claim 3, wherein the graphical information further includes a simulated overhead display of the all-way stop scenario.

5. The intersection assistance system of claim 1, wherein the display includes at least one of (i) an in-dash display and (ii) a display of a central infotainment system of the vehicle.

6. The intersection assistance system of claim 1, wherein the set of vehicle systems includes a perception system configured to perceive an environment external to the vehicle, and wherein the information from the perception system includes a time that each vehicle of the plurality of vehicles arrived at the all-way stop scenario.

7. The intersection assistance system of claim 1, wherein the set of vehicle systems includes a vehicle communication system configured for vehicle-to-anything (V2X) communication.

8. The intersection assistance system of claim 7, wherein the information from the vehicle communication system includes other intersection information received, either directly or via a central server, from one or more of a remainder of the plurality of vehicles.

9. The intersection assistance system of claim 1, wherein the all-way stop scenario is an all-way stop sign scenario.

10. The intersection assistance system of claim 1, wherein the all-way stop scenario is a multi-way intersection that has a malfunctioning traffic light.

11. An intersection assistance method for a vehicle, the intersection assistance method comprising:
obtaining, by a controller and from a set of vehicle systems, intersection information relative to an all-way stop scenario that involves a plurality of vehicles including the vehicle, wherein the intersection information determined by each of the set of vehicle systems collectively forms a set of intersection information; and
in response to detecting the all-way stop scenario, executing, by the controller, an intersection assistance procedure including:
obtaining, from the set of vehicle systems, the set of intersection information;
based on the set of intersection information, determining a sequential order in that the plurality of vehicles should proceed during the all-way stop scenario; and
controlling a display of the vehicle to display graphical information based on the determined sequential order,
wherein the display of the graphical information assists a driver of the vehicle in navigating the all-way stop scenario.

12. The intersection assistance method of claim 11, further comprising updating, by the controller, the sequential order in that a remainder of the plurality of vehicles should proceed after one of the plurality of vehicles has traversed and left the all-way stop scenario.

13. The intersection assistance method of claim 11, wherein the graphical information includes a display of the sequential order of the plurality of vehicles including a current instruction for the driver of the vehicle to either wait and remain stopped, proceed, or proceed with caution.

14. The intersection assistance method of claim 13, wherein the graphical information further includes a simulated overhead display of the all-way stop scenario.

15. The intersection assistance method of claim 11, wherein the display includes at least one of (i) an in-dash display and (ii) a display of a central infotainment system of the vehicle.

16. The intersection assistance method of claim 11, wherein the set of vehicle systems includes a perception system configured to perceive an environment external to the vehicle, and wherein the information from the perception system includes a time that each vehicle of the plurality of vehicles arrived at the all-way stop scenario.

17. The intersection assistance method of claim 11, wherein the set of vehicle systems includes a vehicle communication system configured for vehicle-to-anything (V2X) communication.

18. The intersection assistance method of claim 17, wherein the information from the vehicle communication system includes other intersection information received, either directly or via a central server, from one or more of a remainder of the plurality of vehicles.

19. The intersection assistance method of claim 11, wherein the all-way stop scenario is an all-way stop sign scenario.

20. The intersection assistance method of claim 11, wherein the all-way stop scenario is a multi-way intersection that has a malfunctioning traffic light.
